(19) United States
(12) Patent Application Publication
(10) Pub. No.: US 2008/0135098 A1
(43) Pub. Date: Jun. 12, 2008

(54) COLOR PURITY IMPROVING SHEET, OPTICAL APPARATUS, IMAGE DISPLAY, LIQUID CRYSTAL DISPLAY AND SOLAR CELL

(75) Inventors: Akira OOTANI, Ibaraki-shi (JP); Megumu NAGASAWA, Ibaraki-shi (JP); Michie SAKAMOTO, Ibaraki-shi (JP); Yutaka OHMORI, Ibaraki-shi (JP); Shuusaku NAKANO, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/944,772

(22) Filed: Nov. 26, 2007

(30) Foreign Application Priority Data
Nov. 24, 2006 (JP) 2006-316591

(51) Int. Cl. C09K 19/02

(52) U.S. Cl. 136/263; 428/1.3; 428/1.33

(57) ABSTRACT

A color purity improving sheet that improves color purity while preventing brightness from degrading due to absorption of light of a necessary color. The color purity improving sheet includes a light-emitting layer containing a light-emitting means for absorbing light in a specific wavelength range other than the target wavelength range and converting its wavelength to emit light in the target wavelength range, and a reflective layer. The light-emitting layer has a transmittance of at least 70% at the maximum absorption wavelength of the light-emitting layer. The light-emitting layer and the reflective layer are laminated together in this order in a direction from which light of a backlight is incident. The reflective layer selectively reflects part of light in the specific wavelength range other than the target wavelength range and has been transmitted without being absorbed by the light-emitting means in the light-emitting layer, allowing entrance into the light-emitting layer again.

### CROSS-REFERENCE TO RELATED APPLICATIONS

This application claims priority from Japanese Patent Application No. 2006-316591, filed on Nov. 24, 2006. The entire subject matter of the Japanese Patent Application is incorporated herein by reference.

### BACKGROUND OF THE INVENTION

1. Field of the Invention

The present invention relates generally to color purity improving sheets, optical apparatuses, image displays, liquid crystal displays and solar cells.

2. Description of the Related Art

Sunlight and light emitted from artificial light sources each are a mixture of lights of various colors (wavelengths). When such light is used for devices such as liquid crystal displays (LCD) and solar cells, lights of all colors (wavelengths) are not always used. Accordingly, from the viewpoint of energy efficiency, they are designed so that light of an unnecessary color (wavelength) is used after being converted into light of a necessary color (wavelength). For instance, an optical apparatus for LCDs has been proposed that converts light of an unnecessary color (yellow light with a wavelength of 575 to 605 nm) contained in the light emitted from a light source into light of a necessary color (red light with a wavelength of 610 nm or longer) using a fluorescent material (see JP 2005-276586 A). The light emitted from a cold-cathode tube used generally as a light source has high emission peaks of blue light around 435 nm, green light around 545 nm, and red light around 610 nm, and such light is used for LCDs. When color purity is intended to be improved by converting yellow that is an unnecessary neutral color into red, which is a necessary color, it is ideal to convert only light (yellow) in a wavelength range of 575 to 605 nm, but then a fluorescent material that absorbs only light in a very narrow wavelength range is required. However, the absorption wavelength range of a common fluorescent material has a width of at least 100 nm. For example, even when the maximum absorption wavelength is around 585 nm, green light around 545 nm and red light around 610 nm also are absorbed. As a result, there is a problem in that the brightness of the LCD degrades.

For a method of reducing such absorption of lights of necessary colors, it is conceivable to reduce the concentration of the fluorescent material. However, if the concentration of the fluorescent material is reduced, there is a problem in that improvement in color purity, which is an intended purpose, cannot be achieved.

### SUMMARY OF THE INVENTION

The present invention therefore is intended to provide a color purity improving sheet that can improve the color purity while preventing brightness from degrading due to the absorption of lights of necessary colors. In order to achieve the above-mentioned object, a color purity improving sheet of the present invention includes a light-emitting layer and a reflective layer. The light-emitting layer contains a light-emitting means for improving the purity of a color in a target wavelength range by absorbing light in a specific wavelength range other than the target wavelength range and then converting its wavelength to emit light in the target wavelength range. The light-emitting layer has a transmittance of at least 70% at the maximum absorption wavelength of the light-emitting layer. The light-emitting layer and the reflective layer are laminated together in this order in a direction from which light of a backlight is incident. The reflective layer selectively reflects part of light that is in the specific wavelength range other than the target wavelength range and that has been transmitted without being absorbed by the light-emitting means contained in the light-emitting layer, and allows it to enter the light-emitting layer again. Part of the light that has entered the light-emitting layer passes through the light-emitting layer. The maximum absorption wavelength of the light-emitting layer is included in a selective reflection wavelength range in which the reflective layer selectively reflects light.

An optical apparatus of the present invention is an optical apparatus including a back light (a light source device) and a color purity improving sheet, wherein the color purity improving sheet is the color purity improving sheet of the present invention.

An image display of the present invention is an image display including a color purity improving sheet, wherein the color purity improving sheet is the color purity improving sheet of the present invention.

A liquid crystal display of the present invention is a liquid crystal display including a color purity improving sheet, wherein the color purity improving sheet is the color purity improving sheet of the present invention.

A solar cell of the present invention is a solar cell including a color purity improving sheet, wherein the color purity improving sheet is the color purity improving sheet of the present invention.

The color purity improving sheet of the present invention has a light-emitting layer containing a light-emitting means that improves the purity of a color in the target wavelength range by absorbing light in the specific wavelength range (light of an unnecessary color) other than the target wavelength range and then converting its wavelength to emit light in the target wavelength range (light of a necessary color). The light emitting layer has a transmittance of at least 70% at the maximum absorption wavelength thereof. Accordingly, light in the whole wavelength range passes through the light-emitting layer satisfactorily. Furthermore, the color purity improving sheet of the present invention includes a reflective layer that selectively reflects part of light transmitted without being absorbed by the light-emitting means contained in the light-emitting layer, and allows it to enter the light-emitting layer again. The maximum absorption wavelength of the light-emitting layer is included in the selective reflection wavelength range in which the reflective layer selectively reflects light. Accordingly, some of the lights of unnecessary colors that have been transmitted without being absorbed by the light-emitting means contained in the light-emitting layer and that therefore have not been subjected to wavelength conversion are reflected by the reflective layer and are allowed to enter the light-emitting layer again. The light of an unnecessary color that has entered the light-emitting layer again is absorbed by the light-emitting means contained in the light-emitting layer and light of a necessary color is emitted instead. Therefore the color purity improving sheet of the present invention makes it possible to improve the color purity. The reflective layer allows most part of the light in the range other than the selective reflection wavelength range to be transmitted without reflecting it. Accordingly, the color purity improving sheet of the present invention prevents brightness from degrading due to the absorption of light of a necessary color.

### BRIEF DESCRIPTION OF THE DRAWINGS

FIG. 1 is a cross-sectional view showing an example of the color purity improving sheet according to the present invention.

FIG. 2 is a cross-sectional view showing another example of the color purity improving sheet according to the present invention.

FIG. 3 is a cross-sectional view showing still another example of the color purity improving sheet according to the present invention.

FIG. 4 is a cross-sectional view showing an example of the structure of a liquid crystal display according to the present invention.

FIG. 5 is a graph showing the absorption spectrum in an example of the fluorescent material to be used in the present invention.

FIG. 6 is a graph showing brightness (emission intensity) in one example of the present invention.

FIG. 7 is a graph showing brightness (emission intensity) in another example of the present invention.

### DETAILED DESCRIPTION OF THE INVENTION

In the present invention, “improvement in color purity” embraces, for example, conversion of light of yellow, which is a color between red and green, into light of red or green, conversion of light of a color between green and blue into light of green, and conversion of light of any of red, green, and blue into light of a color other than red, green, and blue.

In the color purity improving sheets of the present invention, it is preferable that the light-emitting layer be formed of a matrix polymer and a fluorescent material.

In the color purity improving sheet of the present invention, it is preferable that the reflective layer be a cholesteric layer formed of a liquid crystal monomer and a chiral agent.

In the color purity improving sheets of the present invention, examples of the fluorescent material include fluoresceins, rhodamines, coumarins, dansyls (dimethylaminonaphthalenesulfonic acids), 7-nitrobenzo-2-oxa-1,3-diazol (NBD) dyes, pyrene, perylene, phycobiliprotein, cyanine pigment, anthraquinone, thioindigo, and benzopyran fluorescent materials. One of the fluorescent materials can be used individually or two or more of them can be used in combination.

In the color purity improving sheet of the present invention, it is preferable that the fluorescent material be a perylene fluorescent material.

In the color purity improving sheet of the present invention, it is preferable that the perylene fluorescent material be represented by the following structural formula (1):

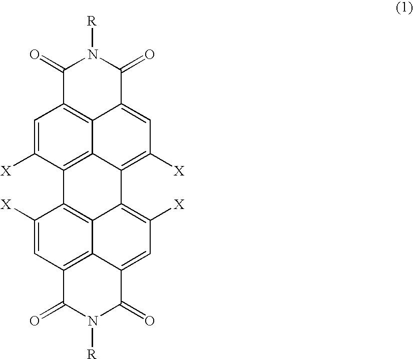

where four Xs each are a halogen group or an alkoxy group, the respective Xs can be identical to or different from one another, and two Rs each are an aryl group or an alkyl group, the respective Rs can be identical to or different from each other.

In the color purity improving sheet of the present invention, examples of the matrix polymer include polymethylmethacrylate, polyacrylic resin, polycarbonate resin, polynorbornene resin, polyvinyl alcohol resin, and cellulose resin. One of the matrix polymers may be used individually or two or more of them may be used in combination.

In the color purity improving sheet of the present invention, it is preferable that the matrix polymer be polymethylmethacrylate.

Now the color purity improving sheet of the present invention is described using examples. However, the color purity improving sheet of the present invention is not limited to the following examples.

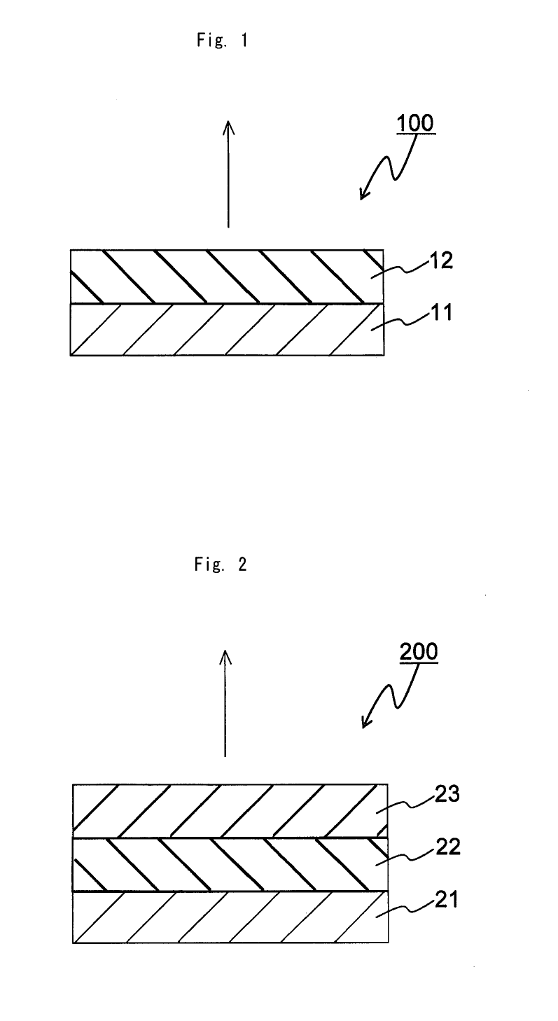

An example of the structure of a color purity improving sheet according to the present invention is shown in a cross-sectional view in FIG. 1. As shown in FIG. 1, this color purity improving sheet 100 includes a light-emitting layer 11 and a reflective layer 12 that are disposed in this order in the direction from which light of a backlight is incident or in a transmission direction (indicated with an arrow). The planar shape of the color purity improving sheet of the present invention is an oblong figure and can be a square or a rectangle but is preferably a rectangle.

As described above, the light-emitting layer contains a light-emitting means.

The light-emitting means improves the purity of a color in the target wavelength range by absorbing the light in the specific wavelength range (light of an unnecessary color) other than the target wavelength range and then converting its wavelength to emit light in the target wavelength range (light of a necessary color).

Preferably, the light-emitting means contains a fluorescent material. Examples of the fluorescent material are as described above.

Specific examples of the fluorescent material include “Lumogen F Red 305 (perylene)” (trade name) manufactured by BASF AG, “Plast Red 8355 and 8365 (anthraquinone), Plast Red D-54 (thioindigo), Plast Red DR-426 and DR-427 (benzopyran)” (trade names) manufactured by Arimoto Chemical Co., Ltd., and “NK-1533 (carbocyanine dye)” (trade name) manufactured by Hayashibara Biochemical Labs., Inc. These fluorescent materials absorb light of yellow (with a wavelength of 560 to 610 nm), which is a color between red and green, and emit light (with a wavelength of 610 to 650 nm) of red.

As described above, it is preferable that the perylene fluorescent material be represented by the structural formula (1). The absorption spectrum of the fluorescent material represented by the structural formula (1) is shown in the graph in FIG. 5. As shown in FIG. 5, this fluorescent material has a maximum absorption wavelength around 585 nm.

As described above, it is preferable that the light-emitting layer be formed of a matrix polymer and a fluorescent material. The light-emitting layer can be produced by, for example, mixing the fluorescent material with a matrix polymer capable of being formed into a film and then forming the mixture into a film. Preferably, the matrix polymer has high transparency and examples thereof include polyacrylic resins such as polymethylmethacrylate, polyethyl acrylate, and polybutyl acrylate; polycarbonate resins such as polyoxycarbonyloxyhexamethylene and polyoxycarbonyloxy-1,4-isopropylidene-1,4-phenylene, polynorbornene resins, polyvinyl alcohol resins such as polyvinyl formal, polyvinyl acetal, and polyvinyl butyral; and cellulose resins such as methylcellulose, ethylcellulose, and derivatives thereof. Among them, polymethylmethacrylate is preferred. One of the matrix polymers may be used individually or two or more of them may be used in combination.

The abovementioned term “polynorbornene resins” denotes (co)polymers obtained with a norbornene monomer having a norbornene ring used for a part or all of a starting material (a monomer). The term “(co)polymers” denotes homopolymers or copolymers.

Next, the method of forming the light-emitting layer is described using an example but is not limited to the example.

First, the matrix polymer is dissolved in a solvent and thereby a polymer solution is prepared. Examples of the solvent to be used herein include toluene, methyl ethyl ketone, cyclohexanone, ethyl acetate, ethanol, tetrahydrofuran, cyclopentanone, and water.

Next, the fluorescent material is dissolved in a solvent and thereby a fluorescent material solution is prepared. The solvent to be used herein can be the same solvent as that used for dissolving the matrix polymer described above.

Subsequently, the polymer solution and the fluorescent material solution are mixed together. The mixture is applied onto a substrate to form a coating film. It is heated to be dried and thus a film is formed. Preferably, the mixture is defoamed before being applied onto the substrate.

Next, the film is separated from the substrate and thereby the light-emitting layer can be obtained.

As described above, the transmittance of the light-emitting layer at the maximum absorption wavelength is at least 70%. If the transmittance at the maximum absorption wavelength is at least 70%, the transmittance in another wavelength range (for instance, a wavelength range of a necessary light) also should be at least 70%. The transmittance of the light-emitting layer at the maximum absorption wavelength is preferably at least 80% and more preferably at least 85%.

The concentration of the fluorescent material in the light-emitting layer can be determined suitably according to the type of the fluorescent material. It is, for example, in the range of 0.001 to 10 parts by weight and preferably in the range of 0.001 to 0.05 part by weight, with respect to 100 parts by weight of the matrix polymer.

In the present invention, a transmittance of the light-emitting layer at the maximum absorption wavelength of at least 70% can be obtained, for example, through adjustment of the transmittance by varying the concentration of the fluorescent material when a fluorescent material is used. In this case, although the degree of light absorption varies according to the type of the fluorescent material, the relationship between the concentration and transmittance in each type of fluorescent material can be determined easily. Accordingly, for example, with an analytical curve prepared beforehand, it is easy for a person skilled in the art to obtain a transmittance of at least 70% without undue trial and error.

The thickness of the light-emitting layer is not particularly limited. It is, for example, in the range of 0.1 to 1000 μm, preferably in the range of 1 to 200 μm, and more preferably in the range of 2 to 50 μm.

The reflective layer selectively reflects part of light that is in the specific wavelength range other than the target wavelength range and that has been transmitted without being absorbed by the light-emitting means contained in the light-emitting layer, and allows it to enter the light-emitting layer again. The maximum absorption wavelength of the light-emitting layer is included in the selective reflection wavelength range in which the reflective layer selectively reflects light.

Examples of the reflective layer include a structure containing a cholesteric material, a multilayer structure formed of organic materials with different refractive indices from each other (for instance, multilayer coating films or multilayer extruded stretch films having different refractive indices from each other) or inorganic materials (for instance, inorganic deposited films), and a sheet-like structure having a specific, periodic, and minute concave-convex structure.

As described above, the reflective layer is preferably a cholesteric layer formed of a liquid crystal monomer and a chiral agent.

The cholesteric layer can be, for example, a cholesteric layer described in JP 2003-287623 A. The selective reflection wavelength range is limited in the range of 100 to 320 nm in the cholesteric layer proposed in the publication, but the cholesteric layer of the present invention is not limited thereto. The description of the publication is incorporated herein as a part of the present specification.

When the cholesteric layer is formed using the liquid crystal monomer described later, the selective reflection wavelength bandwidth Δλ of the cholesteric layer can be expressed by Formula (1) described below:

Δλ=2λ(nₑ−nₒ)/(nₑ+nₒ) (I)

where nₒ is a refractive index with respect to ordinary light of the liquid crystal monomer, nₑ is a refractive index with respect to extraordinary light of the liquid crystal monomer, and λ is a selective reflection center wavelength of the cholesteric layer.

With reference to Formula (1) described above, the selective reflection wavelength bandwidth Δλ is narrowed with a decrease in (nₑ−nₒ). In many of practicable liquid crystal monomers, the selective reflection wavelength bandwidth Δλ is about 30 to 150 nm.

The selective reflection center wavelength λ of the cholesteric layer can be expressed by Formula (II) described below:

λ=(nₑ+nₒ)P/2 (II)

where P is expressed by a helical pitch length (μm) required for one-turn twist of the liquid crystal monomer and depends on the pitch length and the average refractive index of the liquid crystal monomer if the pitch is constant.

Specific examples of the liquid crystal monomer include monomers represented by the following structural formulae (2) to (17).

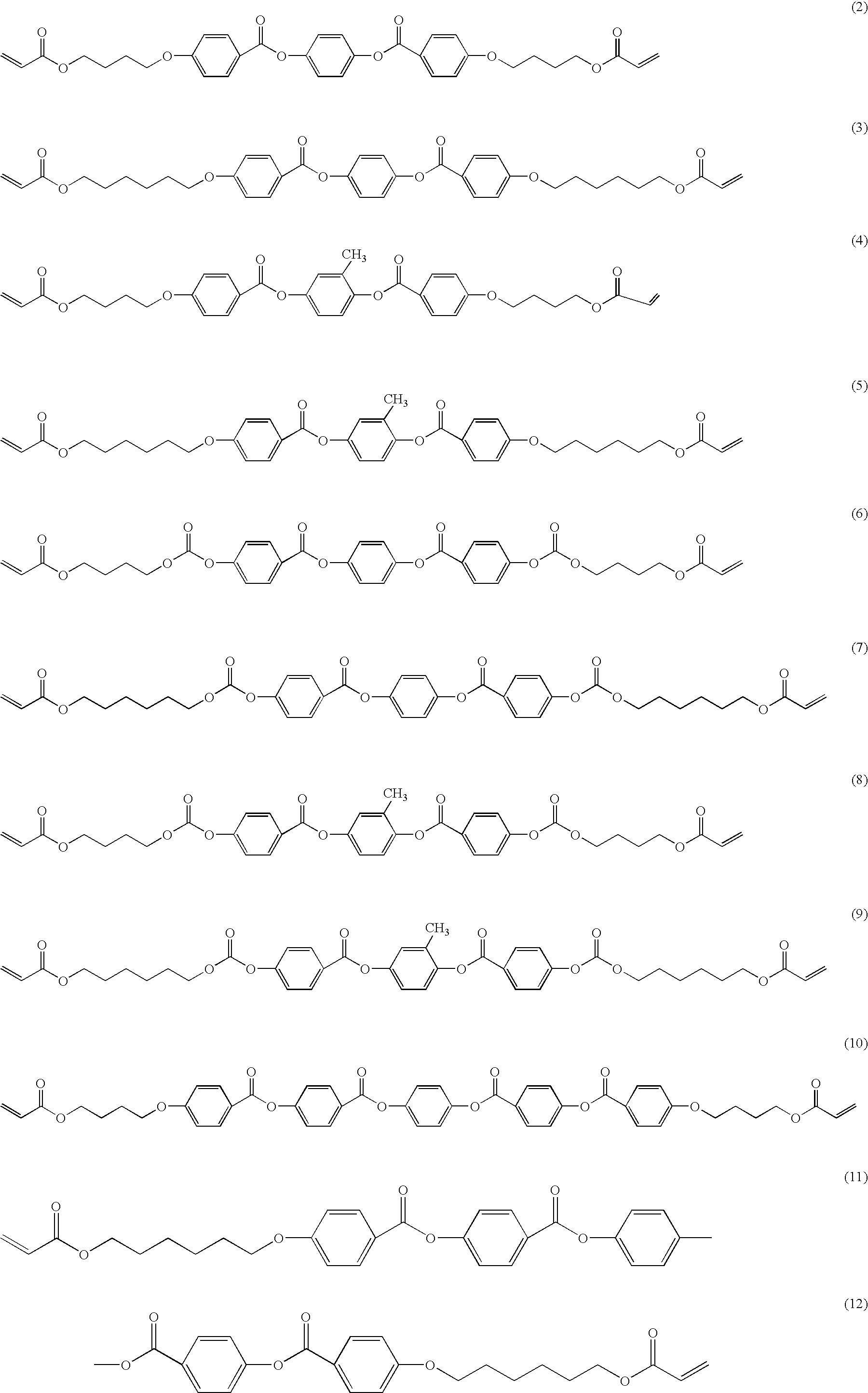

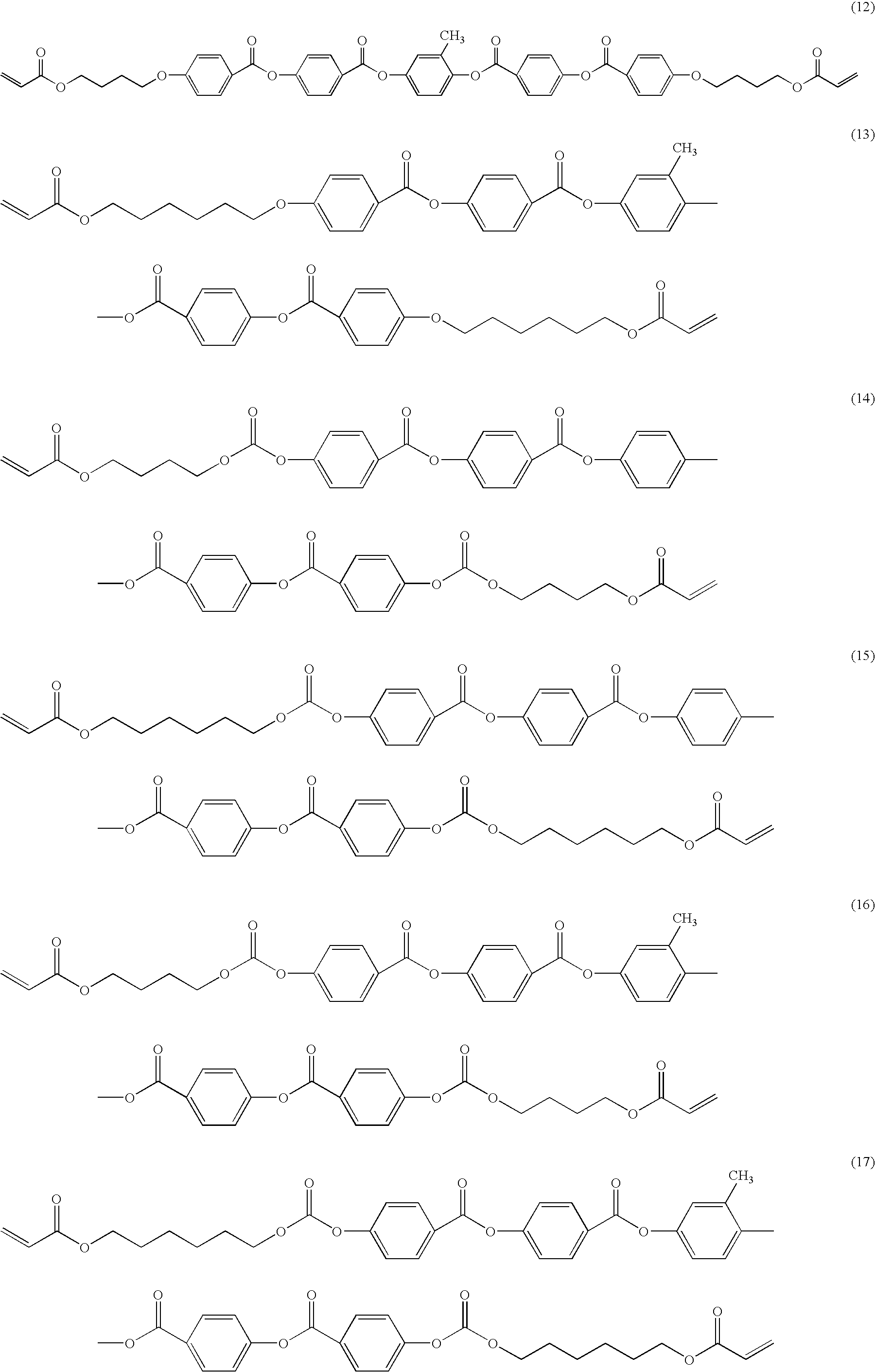

Specific examples of the chiral agent include compounds represented by the following structural formulae (18) to (38).

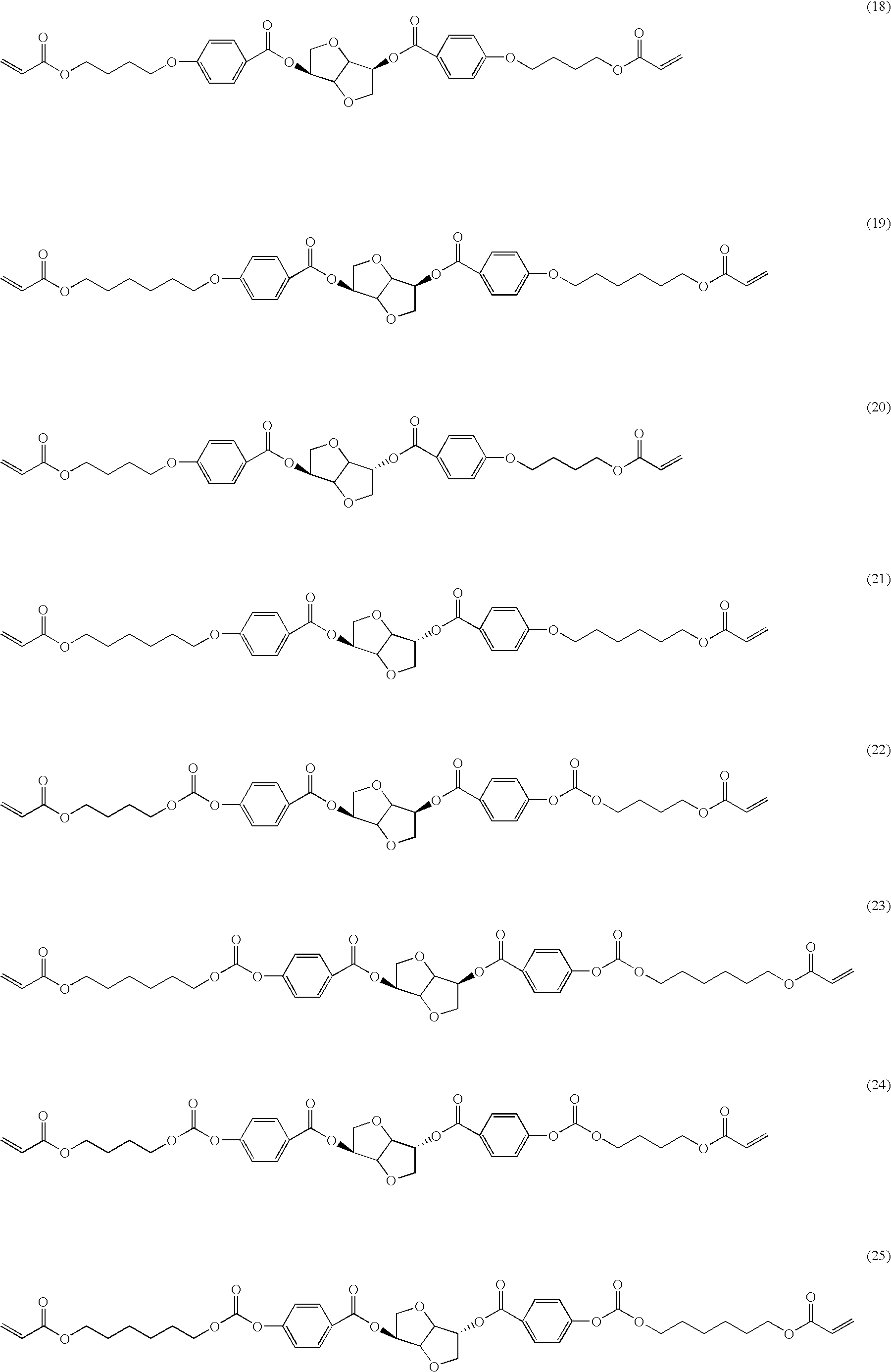

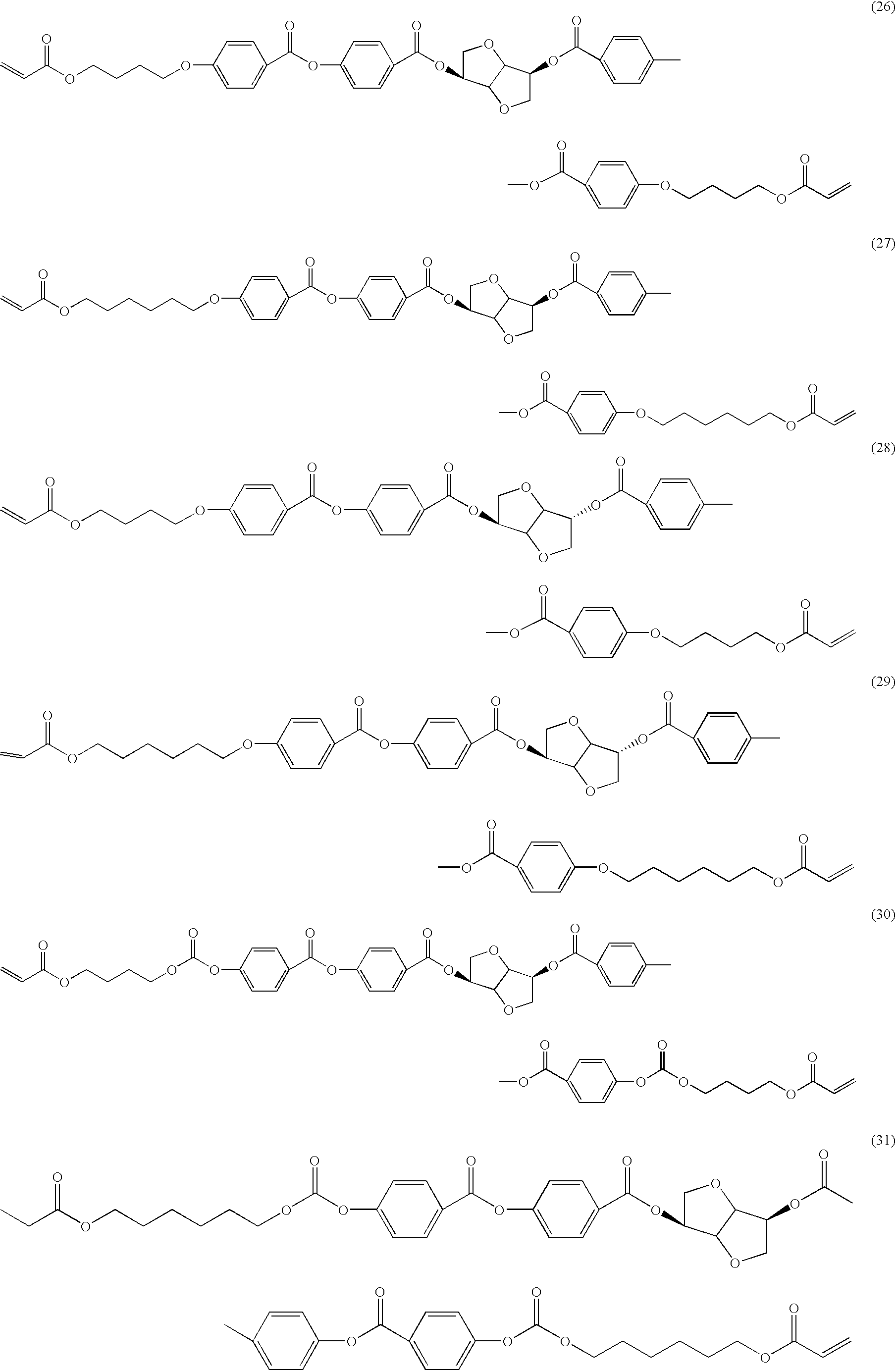

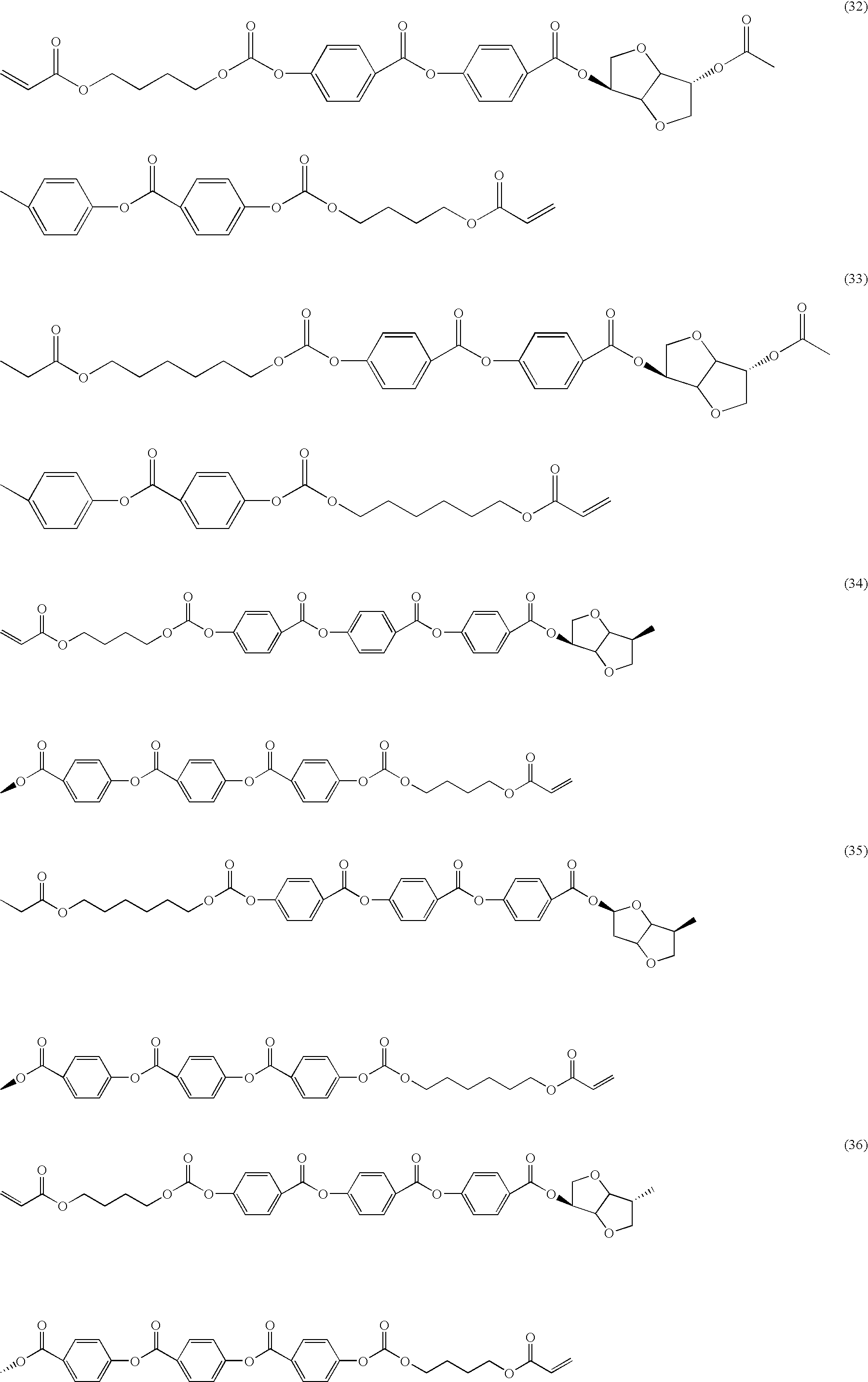

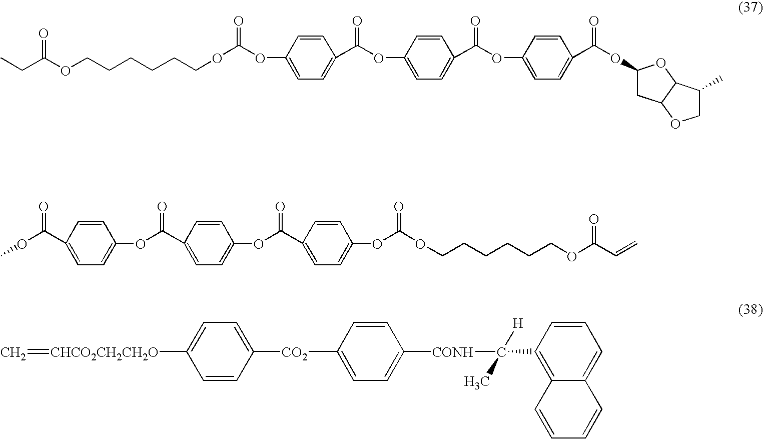

The mixing ratio of the liquid crystal monomer and the chiral agent in the cholesteric layer is determined suitably according to a desired selective reflection wavelength bandwidth Δλ. With respect to 100 parts by weight of the liquid crystal monomer, the chiral agent is, for example, in the range of 2 to 15 parts by weight, preferably in the range of 2 to 13 parts by weight, and more preferably in the range of 2 to 10 parts by weight.

The combination of the liquid crystal monomer and the chiral agent is not particularly limited. Examples thereof include a combination of a liquid crystal monomer represented by the structural formula (9) and a chiral agent represented by the structural formula (33) and a combination of a liquid crystal monomer represented by the structural formula (10) and a chiral agent represented by the structural formula (34).

Next, the method of forming the cholesteric layer is described using an example but is not limited thereto.

First, the liquid crystal monomer, the chiral agent, and at least one of a polymerization initiator and a cross-linking agent are dissolved or dispersed in a solvent. Thus a coating solution is prepared.

Examples of the polymerization initiator to be used herein include a thermopolymerization initiator and a photopolymerization initiator. Examples of the thermopolymerization initiator include benzoyl peroxide (BPO) and azobisisobutyronitrile (AIBN). Examples of the photopolymerization initiator include a series of “IRGACURE” (trade name) manufactured by Ciba Specialty Chemicals Inc. Examples of the cross-linking agent to be used herein include an isocyanate cross-linking agent, an epoxy cross-linking agent, and a metal chelate cross-linking agent. One of them may be used individually or two or more of them may be used in combination. The ratio of the polymerization initiator and the cross-linking agent to be added with respect to the liquid crystal monomer is, for example, in the range of 0.1 to 10% by weight, preferably in the range of 0.5 to 8% by weight, and more preferably in the range of 1 to 5% by weight.

The solvent is not particularly limited. Examples thereof include halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, methoxybenzene, and 1,2-dimethoxybenzene; solvents based on ketones such as acetone, methyl ethyl ketone (MEK), methyl isobutyl ketone, cyclohexanone, cyclopentanone, 2-pyrrolidone, and N-methyl-2-pyrrolidone; solvents based on esters such as ethyl acetate and butyl acetate; solvents based on alcohols such as t-butyl alcohol, glycerol, ethylene glycol, triethylene glycol, ethylene glycol monomethyl ether, diethylene glycol dimethyl ether, propylene glycol, dipropylene glycol, and 2-methyl-2,4-pentanediol; solvents based on amides such as dimethylformamide and dimethylacetoamide; solvents based on nitriles such as acetonitrile and butyronitrile; solvents based on ethers such as diethyl ether, dibutyl ether, tetrahydrofuran, and dioxane; carbon disulfide; ethyl cellosolve; and butyl cellosolve. Among them, preferred solvents are toluene, xylene, mesitylene, MEK, methyl isobutyl ketone, cyclohexanone, ethyl cellosolve, butyl cellosolve, ethyl acetate, butyl acetate, propyl acetate, and ethyl cellosolve acetate. One of these solvents may be used independently, or two or more of them may be used in combination.

Various additives can be mixed suitably into the coating solution if necessary. Examples of the additives include an antioxidant, a denaturant, a surfactant, a dye, a pigment, a discoloration inhibitor, and an ultraviolet absorber. Any one of these additives may be added alone or two or more of them may be used in combination.

Next, the coating solution is applied onto an alignment substrate.

The alignment substrate is not particularly limited as long as it allows the liquid crystal monomers to be aligned. Examples thereof include various plastic films and plastic sheets whose surfaces have been subjected to a rubbing treatment with, for example, rayon cloth. The plastic is not particularly limited. Examples thereof include polyolefins such as triacetyl cellulose (TAC), polyethylene, polypropylene, and poly(4-methylpentene-1); polyimide, polyimideamide, polyetherimide, polyamide, polyether ether ketone, polyether ketone, polyketone sulfide, polyethersulfone, polysulfone, polyphenylene sulfide, polyphenylene oxide, polyethylene terephthalate (PET), polybutylene terephthalate, polyethylene naphthalate, polyacetal, polycarbonate, polyarylate, acrylic resin, polyvinyl alcohol, cellulose plastic, epoxy resin, and phenol resin. Furthermore, for instance, a metallic substrate formed of, for example, aluminum, copper or iron, a ceramic substrate, or a glass substrate also can be used, which is provided with a plastic film or sheet as described above disposed on the surface thereof or a SiO₂ obliquely deposited film formed on the surface thereof. A laminate in which for example, a stretched film having birefringence that has been subjected to a stretching process such as uniaxial stretching is laminated as an alignment film on a plastic film or sheet as described above also can be used as the alignment substrate. Moreover, it is preferable that the substrate itself have birefringence. This is because it is no longer necessary, for example, to subject the surface thereof to the rubbing treatment or to laminate a birefringent film on the surface thereof as described above. Examples of the method of imparting birefringence to such a substrate itself include methods in which, for example, casting or extrusion molding other than the stretching process is carried out in forming the substrate.

The coating solution can be applied onto the alignment substrate by a conventionally known method such as a roll coating method, a spin coating method, a wire bar coating method, a dip coating method, an extrusion coating method, a curtain coating method, or a spray coating method. Among these methods, the spin coating method and the extrusion coating method are preferred from the viewpoints of application efficiency.

Subsequently, the resultant coating film is heat-treated to allow the liquid crystal monomers to be aligned in a liquid crystal state. Since the coating film contains the chiral agent together with the liquid crystal monomers, the liquid crystal monomers brought into the liquid crystal phase (liquid crystal state) are aligned, with a twist being given by the chiral agent. That is, the liquid crystal monomers exhibit a cholesteric structure (a helical structure).

The temperature condition for the heat treatment can be determined suitably according to the type of the liquid crystal monomers, specifically, the temperature at which the liquid crystal monomers exhibit liquid crystallinity. It is, for example, in the range of 40 to 120° C., preferably in the range of 50 to 110° C., and more preferably in the range of 60 to 105° C.

Next, the coating film in which the liquid crystal monomers have been aligned is subjected to a polymerization process or a crosslinking process and thereby the liquid crystal monomers and the chiral agent are polymerized or crosslinked. This allows the liquid crystal monomers to be polymerized/crosslinked with one other or to be polymerized/crosslinked with the chiral agent while they have a cholesteric structure and remain aligned, and thereby the aligned state is fixed. The polymer thus formed becomes a non-liquid crystal polymer due to the fixation of the aligned state. Thus the cholesteric layer can be formed. The cholesteric layer thus formed usually reflects half of the light and transmits the remaining half of the light. Accordingly, the reflectance of the cholesteric layer is approximately 50%.

The polymerization process or crosslinking process can be determined suitably according to, for example, the type of the polymerization initiator or crosslinking agent to be used. For instance, when using a photopolymerization initiator or a photocrosslinking agent, light irradiation can be carried out.

The reflective layer to be used may be one obtained by removing the cholesteric layer from the alignment substrate or one with the cholesteric layer that remains laminated on the alignment substrate.

When the reflective layer to be used is one with the cholesteric layer laminated on the alignment substrate, the alignment substrate is preferably a translucent plastic film. Examples of the translucent plastic film include those formed of celluloses such as TAC; polyolefin such as polyethylene, polypropylene, and poly(4-methylpentene-1); and polyimide, polyamide imide, polyamide, polyetherimide, polyether ether ketone, polyketone sulfide, polyethersulfone, polysulfone, polyphenylene sulfide, polyphenylene oxide, PET, polybutylene terephthalate, polyethylene naphthalate, polyacetal, polycarbonate, polyarylate, acrylic resin, polyvinyl alcohol, cellulose plastics, epoxy resin, phenol resin, polynorbornene, polyester, polystyrene, polyvinyl chloride, polyvinylidene chloride, and liquid crystal polymer. These films can be optically isotropic or anisotropic. Among these plastic films, respective films formed of polypropylene, PET, and polyethylene naphthalate are preferred from the viewpoints of solvent resistance and heat resistance.

The translucent alignment substrate as described above may be, for example, a single layer but also may be a laminate including layers formed of different types of polymers laminated together from the viewpoints of, for example, improvement in strength, heat resistance, and adhesiveness of polymer or liquid crystal polymer.

The thickness of the reflective layer is not particularly limited. It is, for example, in the range of 0.01 to 200 μm, preferably in the range of 0.1 to 100 μm, and more preferably in the range of 1 to 10 μm.

The reflectance (the maximum reflectance) at the selective reflection center wavelength λ of the reflective layer is preferably as high as possible, and is, for example, in the range of 30 to 99%. For the reflective layer to have a maximum reflectance of at least 50%, for instance, the method described later can be employed. The maximum reflectance can be determined by, for example, the method described later in the section of Example.

The method of laminating the light-emitting layer and the reflective layer together is not particularly limited. They may be stacked simply together or a conventionally known method in which an adhesive or a pressure-sensitive adhesive is used also can be employed. Furthermore, in the color purity improving sheet of this example, the light-emitting layer and the reflective layer do not always need to be in contact with each other, and another layer may be interposed therebetween.

The specific wavelength range in which light is absorbed by the light-emitting layer is not particularly limited and can be, for example, in the range of 500 to 600 nm. The target wavelength range of light emitted by the light-emitting layer is not particularly limited and can be, for example, in the range of 600 to 750 nm. The selective reflection wavelength range in which the reflective layer selectively reflects light is not particularly limited and can be, for example, in the range of 550 to 600 nm.

Another example of the structure of the color purity improving sheet according to the present invention is shown in the cross-sectional view in FIG. 2. As shown in FIG. 2, this color purity improving sheet 200 includes a light-emitting layer 21, a first reflective layer 22, and a second reflective layer 23 that are disposed in this order in the direction from which light of a backlight is incident or in a transmission direction (indicated with an arrow). The first reflective layer 22 and the second reflective layer 23 each are the cholesteric layer. The above-mentioned two cholesteric layers have opposite twists to each other. With such a structure, the maximum reflectance further can be improved, and can be, for example, at least 50%. In this example, the maximum reflectance is, for example, in the range of 50 to 99%.

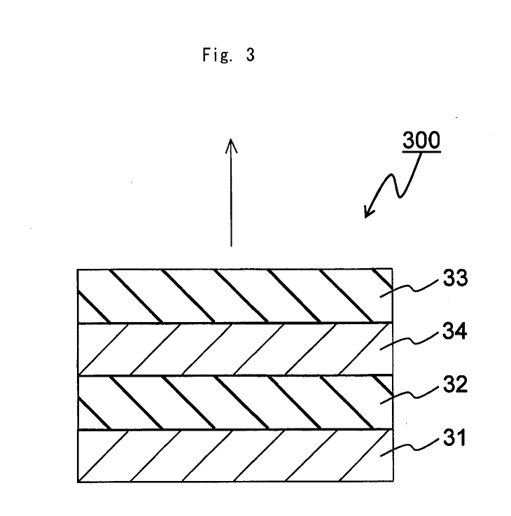

Still another example of the structure of the color purity improving sheet according to the present invention is shown in the cross-sectional view in FIG. 3. As shown in FIG. 3, this color purity improving sheet 300 includes a light-emitting layer 31, a first reflective layer 32, a retardation plate 34, and a second reflective layer 33 that are disposed in this order in the direction from which light of a backlight is incident or in a transmission direction (indicated with an arrow). The first reflective layer 32 and the second reflective layer 33 each are the cholesteric layer. The above-mentioned two cholesteric layers have the same twist. In this case, the above-mentioned two cholesteric layers may be identical to or different from each other as long as they have the same twist. The retardation plate 34 is one having a phase difference (λ/2) corresponding to the half the selective reflection center wavelength λ of the two cholesteric layers having the same twist. Even with the structure as described above, the maximum reflectance can be improved further and can be, for example, at least 50%. In this example, the maximum reflectance is, for instance, in the range of 50 to 99%.

Examples of the material for the retardation plate include: birefringent films obtained through a stretching process performed with respect to polymer films formed of, for example, polycarbonate, polyvinyl alcohol, polystyrene, polymethylmethacrylate, polypropylene, other polyolefins, polyarylate, polyamide, and polynorbornene; alignment films of liquid crystal polymers; and laminates, each of which has a film supporting an alignment layer of a liquid crystal polymer. The retardation plate may be self-produced or a commercially available one may be used.

The optical apparatus of the present invention has a configuration including a back light (a light source device) and the color purity improving sheet of the present invention.

The light source device is not particularly limited. Examples thereof include a cold cathode tube and a light emitting diode (LED).

The color purity improving sheet of the present invention can be used advantageously for various image displays such as liquid crystal displays (LCD) and EL displays (ELD) as well as solar cells.

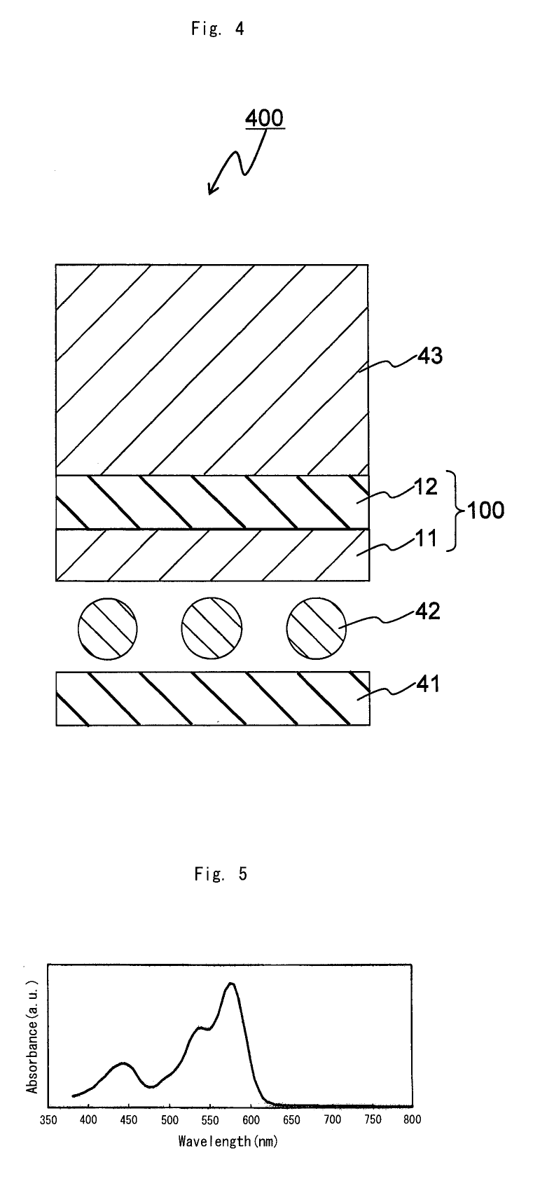

The liquid crystal display of the present invention is described using an example in which the color purity improving sheet shown in FIG. 1 was used. The configuration of the liquid crystal display of this example is shown in the cross-sectional view in FIG. 4. In FIG. 4, identical parts as those shown in FIG. 1 are indicated with the same numbers. In FIG. 4, in order to make it clearly understandable, for example, the sizes and ratios of respective components differ from actual ones. As shown in FIG. 4, the liquid crystal display 400 of this example includes a color purity improving sheet 100, a diffusion reflection plate 41, a light source device 42, and a liquid crystal panel 43 as main components. The light source device 42 is disposed on the light-emitting layer 11 side of the color purity improving sheet 100. The diffusion reflection plate 41 is disposed on the opposite side of the light source device 42 to the color purity improving sheet 100. Furthermore, the liquid crystal panel 43 is disposed on the reflective layer 12 side of the color purity improving sheet 100. With the liquid crystal display 400 of this example, the case is illustrated where the direct type is employed in which the light source device 42 is disposed directly under the liquid crystal panel 43 via the color purity improving sheet 100. However, the present invention is not limited thereto and it may employ, for example, a side light type. In the side light type, at least a light guide plate and a light reflector also are provided in addition to the components of the direct type. Similarly in the case of the aforementioned direct type, a light guide plate further can be disposed between the light source device and the color purity improving sheet.

In the liquid crystal display of this example, improvement in color purity is carried out, for example, as follows. For instance, assume that, for example, a device that has high emission peaks of blue, green, and red lights around 435 nm, 545 nm, and 610 nm, respectively, is used for the light source device 42, the liquid crystal display 400 uses only the emissions of green and red lights, and the emission of yellow light (around 585 nm), which is light of a color between green and red, is not required. In this case, the light-emitting layer 11 is allowed to contain a fluorescent material that has a maximum absorption wavelength around 585 nm and emits light with a wavelength of 610 nm or longer. Furthermore, the reflective layer 12 to be used is one that selectively reflects only light around 585 nm, for example. In this case, light that is yellow light emitted from the light source device 42 and has transmitted without being absorbed by the fluorescent material contained in the light-emitting layer 11 and therefore has not been subjected to wavelength conversion is reflected by the reflective layer 12 to enter the light-emitting layer 11 again. Furthermore, part of the light that has entered the light-emitting layer 11 again passes through the light-emitting layer 11 and is reflected by the diffusion reflection plate 41 to enter the light-emitting layer 11 once again. As described above, since yellow light that has passed through the light-emitting layer 11 is reflected by the reflective layer 12 or the diffusion reflection plate 41 to enter the light-emitting layer 11 repeatedly, the yellow light is converted sequentially into red light by the fluorescent material contained in the light-emitting layer 11. This allows light emitted from the light source device 42 to have improved color purity. On the other hand, light of necessary colors such as green light around 545 nm is transmitted through the color purity improving sheet 100 at a transmittance of at least 70% to enter the liquid crystal panel 43. Accordingly, degradation in brightness is prevented. Moreover, light emitted from the light source device 42 and the light-emitting layer 11 to the diffusion reflection plate 41 side also is reflected by the diffusion reflection plate 41 to enter the light-emitting layer 11.

The image display of the present invention is used for any suitable applications. Examples of the applications include office equipment such as a desktop PC, a notebook PC, and a copy machine, portable devices such as a mobile phone, a watch, a digital camera, a personal digital assistant (PDA), and a handheld game machine, home electric appliances such as a video camera, a television set, and a microwave oven, vehicle equipment such as a back monitor, a monitor for a car-navigation system, and a car audio, display equipment such as an information monitor for stores, security equipment such as a surveillance monitor, and care and medical equipment such as a monitor for health care and a monitor for medical use.

### EXAMPLES

Next, examples of the present invention are described together with comparative examples. The present invention is neither limited nor restricted by the following examples or comparative examples. Measurement and evaluation of various characteristics and physical properties in the respective examples and comparative examples were carried out by the following methods. The light source device used in each example and comparative example was one having high emission peaks of blue light around 435 nm, green light around 545 nm, and red light around 610 nm. Furthermore, in each example and comparative example, only emissions of blue, green, and red lights were required and emission of yellow light (around 585 nm), which is light of a color between green and red, was not required.

### (1) Brightness

With any one of a color purity improving sheet, a stretched PET film, and a light-emitting layer being placed on a light source device, the brightness (absolute energy of emission intensity: μW/cm²/nm) was measured with a spectrophotometer (manufactured by Otsuka Electronics Co., Ltd., “Multi Channel Photo Detector, MCPD-3000” (trade name)). In this case, the light-receiving unit was disposed 3 cm above the color purity improving sheet (on the opposite side to the light source device).

### (2) Selective Reflection Center Wavelength λ, Maximum Reflectance, and Selective Reflection Bandwidth (Δλ)

The reflection spectrum of the reflective layer was measured with the spectrophotometer (manufactured by Otsuka Electronics Co., Ltd., “Multi Channel Photo Detector, MCPD-3000” (trade name)), and thereby the selective reflection center wavelength λ and maximum reflectance were determined. Then the wavelength bandwidth in which the reflectance that was half the maximum reflectance was obtained was taken as the selective reflection bandwidth (Δλ).

### Example 1

### Production of Light Emitting Layer

First, polymethyl methacrylate resin (manufactured by Kuraray Co., Ltd., “PARAPET EH-1000P” (trade name)) was dissolved in toluene and thereby 30% by weight of polymer solution was prepared. Subsequently, a fluorescent material (manufactured by BASF Corporation, “Lumogen F Red 305” (trade name)) represented by the aforementioned structural formula (1) was dissolved in toluene and thereby 1% by weight of fluorescent material solution was prepared. Then 100 parts by weight of the polymer solution and 1.2 parts by weight of the fluorescent material solution were mixed together with a hybrid mixer, which was then subjected to a defoaming process. The mixture thus obtained was cast onto a PET base material with an applicator and was then dried at 90° C. for 20 minutes. Thus a film was obtained. This film was separated from the PET base material and thereby a light-emitting layer of this example was obtained. This light-emitting layer had a thickness of 30 μm. This light-emitting layer had a transmittance of 91% at a wavelength of 545 nm and had a transmittance of 87.65% at the maximum absorption wavelength thereof, 577 nm. Furthermore, this light-emitting layer had a transmittance of 88.72% at the selective reflection center wavelength λ (585 nm) of the reflective layer described later.

### [Production of Reflective Layer]

100 parts by weight of photopolymerizable nematic liquid crystal monomer (manufactured by BASF Corporation, “LC242” (trade name)) represented by the structural formula (8), 4.75 parts by weight of polymerizable chiral agent (manufactured by BASF Corporation, “LC756” (trade name)) represented by the structural formula (33), 5 parts by weight of photopolymerization initiator (manufactured by Ciba Specialty Chemicals, “IRGACURE 907” (trade name)), and 385 parts by weight of solvent (MEK) were mixed together and thus a coating solution was prepared. The coating solution was applied onto a stretched PET film with a wire bar, which was then heat-treated at 100° C. for one minute. Thus a coating film with a uniform aligned state was obtained. The coating film thus obtained was irradiated with ultraviolet light (at an exposure illuminance of 65 mW/cm² for a total exposure time of 10 seconds), so that the aligned state was fixed. Thus a reflective layer of this example was obtained. The selective reflection center wavelength λ of the reflective layer was 585 nm. The reflective layer had a selective reflection wavelength bandwidth Δλ of 85 nm and a reflectance (the maximum reflectance) of 38% at the selective reflection center wavelength λ (585 nm).

### [Production of Color Purity Improving Sheet]

The reflective layer was placed on one side of the light-emitting layer, so that the light-emitting layer and the reflective layer were laminated together. Thus a color purity improving sheet 100 having the structure shown in FIG. 1 was obtained.

### [Measurement of Brightness]

The color purity improving sheet 100 was placed on a light source device, with the light-emitting layer 11 being located on the light source device side, and thereby the brightness was measured.

### Example 2

The light-emitting layer obtained in Example 1, the reflective layer obtained in Example 1, a retardation plate, and the reflective layer obtained in Example 1 were placed sequentially on top of one another to be laminated. Thus, a color purity improving sheet 300 having the structure shown in FIG. 3 was obtained. The retardation plate used herein was a retardation plate (manufactured by Nitto Denko Corporation, “NRF” (trade name)) with a phase difference of 295 nm. The selective reflection center wavelength λ of the reflective layer of this example was 585 nm. The reflective layer had a selective reflection wavelength bandwidth Δλ of 90 nm and a reflectance (the maximum reflectance) of 59% at the selective reflection center wavelength λ (585 nm).

The color purity improving sheet 300 was placed on the light source device, with the light-emitting layer 31 being located on the light source device side, and thereby the brightness was measured.

### Comparative Example 1

The stretched PET film alone, which was used in Example 1, was placed on the light source device and thereby the brightness was measured.

### Comparative Example 2

The light-emitting layer alone, which was obtained in Example 1, was placed on the light source device and thereby the brightness was measured.

### Comparative Example 3

A light-emitting layer of this comparative example was obtained in the same manner as in Example 1 except that 100 pars by weight of polymer solution and 5.7 parts by weight of fluorescent material solution were mixed together. The thickness of this light-emitting layer was 30 μm. This light-emitting layer had a transmittance of 59% at a wavelength of 545 nm. This light-emitting layer had a transmittance of 44.49% at the maximum absorption wavelength thereof, 577 nm. Furthermore, this light-emitting layer had a transmittance of 48.11% at a wavelength of 585 nm.

The light-emitting layer alone was placed on the light source device and thereby the brightness was measured.

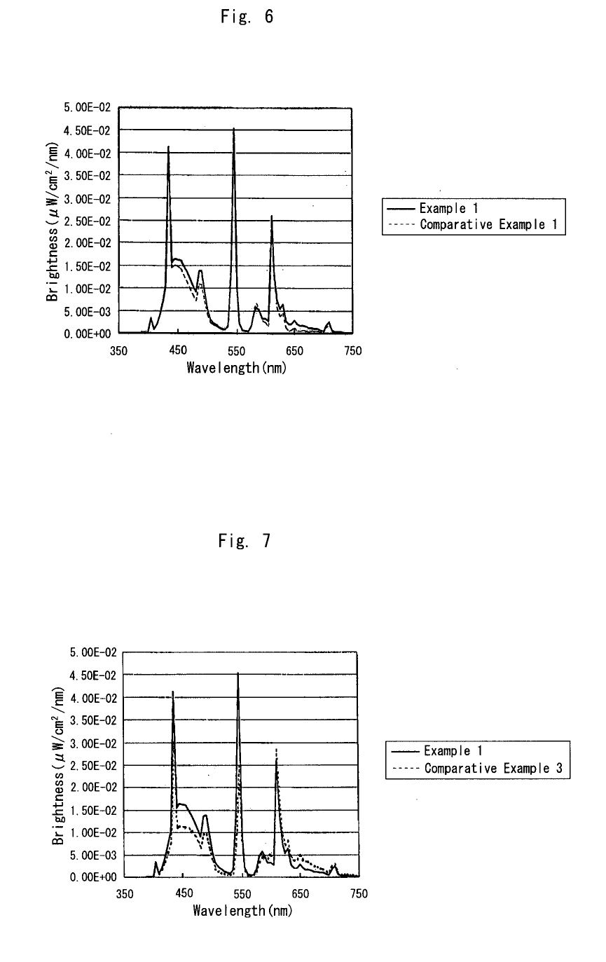

FIG. 6 shows a graph in which measurement results of brightness of Example 1 and Comparative Example 1 are compared to each other. FIG. 7 shows a graph in which measurement results of brightness of Example 1 and Comparative Example 3 are compared to each other. Moreover, Table 1 below shows the increment (%) of emission intensity (1×) at typical wavelengths of Examples 1 and 2 as well as Comparative Examples 2 and 3 with respect to emission intensity (I_{0λ}) of Comparative Example 1. Specifically, the increment was calculated by Formula (III) below:

Increment (%)={(I_{λ}−I_{0λ})/I_{0λ}}×100 (III)

where I_{λ} is emission intensity (μW/cm²/nm) at typical wavelengths of Examples 1 and 2 as well as Comparative Examples 2 and 3, and I_{0λ} is emission intensity (μW/cm²/nm) at typical wavelengths of Comparative Example 1.

TABLE 1

| | | | Compara- | Compara- | Compara- |
|---|---|---|---|---|---|
| Wavelength | | | tive | tive | tive |
| (nm) | Example 1 | Example 2 | Example 1 | Example 2 | Example 3 |
| 435 (blue) | 6.5 | 6.4 | 0.0 | 0.1 | −22.7 |
| 545 (green) | 10.8 | 18.0 | 0.0 | −3.9 | −39.8 |
| 585 (yellow) | −11.9 | −23.9 | 0.0 | 2.1 | −32.3 |
| 610 (red) | 4.6 | −12.6 | 0.0 | 12.7 | 14.0 |
| 630 (red) | 45.7 | 45.3 | 0.0 | 35.1 | 81.2 |
| 650 (red) | 128.2 | 142.5 | 0.0 | 92.1 | 277.3 |

As can be seen from FIG. 6 and Table 1 above, emission of yellow light around 585 nm was suppressed and emissions of blue light around 435 nm, green light around 545 nm, and red light around 610, 630, and 650 nm were enhanced in Example 1 as compared to Comparative Example 1 in which the stretched PET film alone was placed on the light source device. In Example 2, emission of red light around 610 nm was slightly weaker as compared to Comparative Example 1 but was sufficiently high. The result obtained in Example 2 was substantially equivalent to that of Example 1. On the other hand, in Comparative Example 2 in which the light-emitting layer alone was placed on the light source device, the emission of yellow light around 585 nm was not suppressed while the emission of green light around 545 nm was suppressed. As can be seen from FIG. 7 and Table 1 above, in Comparative Example 3 in which only the light-emitting layer with a transmittance of 44.49% at the maximum absorption wavelength thereof was placed on the light source device, the emission of yellow light around 585 nm was suppressed, while the emissions of red lights around 610, 630, and 650 nm were enhanced but the emissions of blue light around 435 nm and green light around 545 nm were suppressed considerably.

As described above, the color purity improving sheet of the present invention allows color purity to be improved while preventing the brightness from degrading due to the absorption of light of necessary colors. Accordingly, the color purity improving sheet of the present invention can be used suitably, for example, for image displays and solar cells. The applications thereof, however, were not limited and they are applicable over a wide range of fields.

The invention may be embodied in other forms without departing from the spirit or essential characteristics thereof. The Examples disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A color purity improving sheet, comprising:
a light-emitting layer which improves purity of a color in a target wavelength range by absorbing light in a specific wavelength range other than the target wavelength range and converts the absorbed light to emitted light in the target wavelength range, and
a reflective layer,
wherein the light-emitting layer has a transmittance of at least 70% at a maximum absorption wavelength of the light-emitting layer,
the light-emitting layer and the reflective layer are laminated together in this order in a direction from which light of a backlight is incident,
the reflective layer selectively reflects part of light that is in the specific wavelength range other than the target wavelength range and that has been transmitted without being absorbed by the light-emitting means contained in the light-emitting layer, the reflected light enters the light-emitting layer again, and part of the light that has again entered the light-emitting layer passes through the light-emitting layer, and
the maximum absorption wavelength of the light-emitting layer is included in a selective reflection wavelength range in which the reflective layer selectively reflects light.

2. The color purity improving sheet according to claim 1, wherein the light-emitting layer is formed of a matrix polymer and a fluorescent material.

3. The color purity improving sheet according to claim 1, wherein the reflective layer is a cholesteric layer formed of a liquid crystal monomer and a chiral agent.

4. The color purity improving sheet according to claim 2, wherein the fluorescent material is at least one selected from the group consisting of fluoresceins, rhodamines, coumarins, dansyls, 7-nitrobenzo-2-oxa-1,3-diazole pigments, pyrene, perylenes, phycobiliproteins, cyanine pigments, anthraquinones, thioindigoes, and benzopyrans.

5. The color purity improving sheet according to claim 4, wherein the fluorescent material is a perylene fluorescent material.

6. The color purity improving sheet according to claim 5, wherein the perylene fluorescent material is represented by the following structural formula (1): 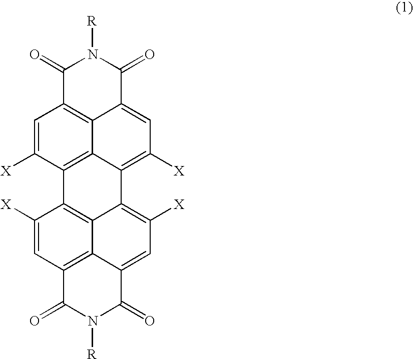
where four Xs each are a halogen group or an alkoxy group, the respective Xs can be identical to or different from one another, and two Rs each are an aryl group or an alkyl group, the respective Rs can be identical to or different from each other.

7. The color purity improving sheet according to claim 2, wherein the matrix polymer is at least one selected from the group consisting of polymethylmethacrylate, polyacrylic resin, polycarbonate resin, polynorbornene resin, polyvinyl alcohol resin, and cellulose resin.

8. The color purity improving sheet according to claim 7, wherein the matrix polymer is polymethylmethacrylate.

9. An optical apparatus comprising a back light and a color purity improving sheet, wherein the color purity improving sheet is a color purity improving sheet according to claim 1.

10. An image display comprising a color purity improving sheet, wherein the color purity improving sheet is a color purity improving sheet according to claim 1.

11. A liquid crystal display comprising a color purity improving sheet, wherein the color purity improving sheet is a color purity improving sheet according to claim 1.

12. A solar cell comprising a color purity improving sheet, wherein the color purity improving sheet is a color purity improving sheet according to claim 1.
